(19) United States
(12) Patent Application Publication
(10) Pub. No.: US 2014/0149730 A1
(43) Pub. Date: May 29, 2014

(54) SYSTEMS AND METHODS FOR ENFORCING SECURE BOOT CREDENTIAL ISOLATION AMONG MULTIPLE OPERATING SYSTEMS

(71) Applicant: DELL PRODUCTS L.P., Round Rock, TX (US)

(72) Inventors: Anand Joshi, Round Rock, TX (US); Douglas M. Anson, Dripping Springs, TX (US); Ricardo L. Martinez, Leander, TX (US)

(73) Assignee: Dell Products L.P., Round Rock, TX (US)

(21) Appl. No.: 13/685,054

(22) Filed: Nov. 26, 2012

(51) Int. Cl. G06F 21/57

(52) U.S. Cl. CPC G06F 21/572
USPC 713/2

(57) ABSTRACT

A method may include designating a key exchange key as an active key exchange key for a boot session of the information handling system. The method may further include during the boot session, in response to a call for updating a value of an authorized database of keys associated with executable code permitted to execute on the information handling system or an authorized database of keys associated with executable code forbidden to execute on the information handling system: determining whether the value is digitally signed with the active key exchange key, determining whether the update is to a database or database entry associated with the active key exchange key, and processing the update in response to determinations that the value is digitally signed with the active key exchange key and that the update is to a database or database entry associated with the active key exchange key.

### TECHNICAL FIELD

The present disclosure relates in general to information handling systems, and more particularly to enforcing secure boot credential isolation among multiple operating systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A key component of almost every information handling system is the basic input/output system (BIOS). A BIOS may be a system, device, or apparatus configured to identify, test, and/or initialize one or more information handling resources of information handling system, typically during boot up or power on of an information handling system. A BIOS may include boot firmware configured to be the first code executed by a processor of an information handling system when the information handling system is booted and/or powered on. As part of its initialization functionality, BIOS code may be configured to set components of the information handling system into a known state, so that one or more applications (e.g., an operating system or other application programs) stored on compatible media may be executed by a processor and given control of the information handling system and its various components.

The Unified Extensible Firmware Interface (UEFI) is a specification that defines a software interface between an operating system and platform firmware. UEFI is meant as a replacement for the traditional BIOS firmware interface, present in many information handling systems. The UEFI specification defined a protocol known as Secure Boot, which may secure the boot process of an information handling system by preventing the loading of drivers or operating system loaders that are not signed with an acceptable digital signature. When Secure Boot is enabled, it is initially placed in “Setup” mode, which allows a public key known as the “Platform Key” (PK) to be written to the information handling firmware. Once the key is written, secure boot enters “User” mode, where only drivers and operating system loaders signed with the PK may be loaded by the firmware. Additional public “Key Exchange Keys” (KEK) may be added to a database stored in computer-readable media accessible to the BIOS/UEFI to allow other certificates to be used.

Typically, KEKs are owned by third-party vendors (e.g., operating system vendors) to allow and disallow specific signed executable code from running as part of the BIOS/UEFI boot process. The authorized and unauthorized code signature databases may be stored in computer-readable media accessible to the BIOS/UEFI and are known in the UEFI as the DB and DBX, respectively. As set forth in the UEFI specification, using current approaches, all owners of KEKs have complete privileges with respect to adding, deleting, or modifying any signature entry in the DB and DBX databases. This may pose disadvantages where multiple KEKs are present.

For example, consider an information handling system that has a BIOS with a capability to support Secure Boot on two different operating systems: OS1 and OS2. Using existing approaches, the BIOS will need to have two separate but equally privileged KEKs to support Secure Boot for both operating systems. Accordingly, the owner of the KEK for OS2 could potentially delete DB and DBX entries for OS1, thereby compromising the functionality of OS1. Furthermore, a security compromise of a KEK of a vendor of one operating system could potentially affect many information handling systems, including those that were not originally included with the compromised vendor's operating system.

### SUMMARY

In accordance with the teachings of the present disclosure, the disadvantages and problems associated with enforcing secure boot credential isolation among multiple operating systems have been reduced or eliminated.

In accordance with embodiments of the present disclosure, an information handling system may include a processor and a basic input/output system (BIOS). The BIOS may include a program of instructions executable by the processor and configured to cause the processor to: (i) during a boot of the information handling system, authenticate an operating system for execution on the information handling system based on a key exchange key associated with the operating system; (ii) designate the key exchange key as an active key exchange key for a boot session of the information handling system; and (iii) during the boot session, in response to a call for updating a value of an authorized database of keys associated with executable code permitted to execute on the information handling system or an authorized database of keys associated with executable code forbidden to execute on the information handling system: determine whether the value is digitally signed with the active key exchange key, determine whether the update is to a database or database entry associated with the active key exchange key, and process the update in response to determinations that the value is digitally signed with the active key exchange key and that the update is to a database or database entry associated with the active key exchange key.

In accordance with these and other embodiments of the present disclosure, a method may include during a boot of the information handling system, authenticating an operating system for execution on an information handling system based on a key exchange key associated with the operating system. The method may also include designating the key exchange key as an active key exchange key for a boot session of the information handling system. The method may further include during the boot session, in response to a call for updating a value of an authorized database of keys associated with executable code permitted to execute on the information handling system or an authorized database of keys associated with executable code forbidden to execute on the information handling system: determining whether the value is digitally signed with the active key exchange key, determining whether the update is to a database or database entry associated with the active key exchange key, and processing the update in response to determinations that the value is digitally signed with the active key exchange key and that the update is to a database or database entry associated with the active key exchange key.

In accordance with these and other embodiments of the present disclosure, an article of manufacture may include a computer readable medium and computer-executable instructions carried on the computer readable medium. The instructions may readable by a processor, the instructions, when read and executed, for causing the processor to: (i) during a boot of the information handling system, authenticate an operating system for execution on an information handling system based on a key exchange key associated with the operating system; (ii) designate the key exchange key as an active key exchange key for a boot session of the information handling system; and (iii) during the boot session, in response to a call for updating a value of an authorized database of keys associated with executable code permitted to execute on the information handling system or an authorized database of keys associated with executable code forbidden to execute on the information handling system: determine whether the value is digitally signed with the active key exchange key, determine whether the update is to a database or database entry associated with the active key exchange key, and process the update in response to determinations that the value is digitally signed with the active key exchange key and that the update is to a database or database entry associated with the active key exchange key.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system with a BIOS configured to enforce credential isolation among multiple operating systems, in accordance with certain embodiments of the present disclosure;

FIG. 2 illustrates a representation of an example key exchange key association map used by the BIOS depicted in FIG. 1, in accordance with certain embodiments of the present disclosure;

FIG. 3 illustrates a flow chart of an example method for initializing an information handling system to enforce credential isolation among multiple operating systems, in accordance with certain embodiments of the present disclosure; and

FIG. 4 illustrates a flow chart of an example method for enforcing credential isolation among multiple operating systems, in accordance with certain embodiments of the present disclosure.

### DETAILED DESCRIPTION

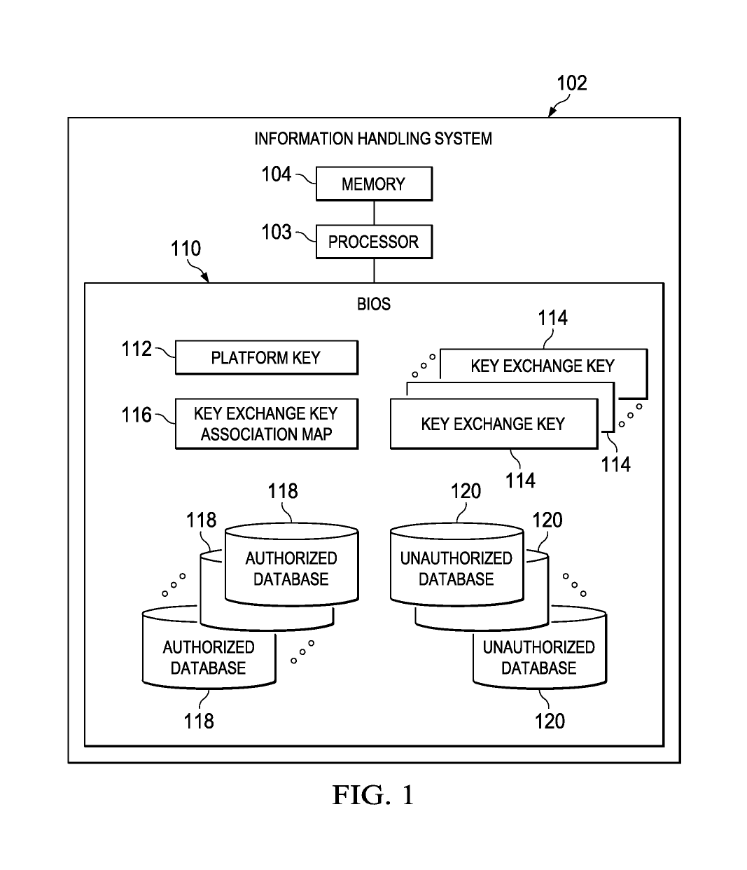

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, BIOSs, busses, memories, I/O devices and/or interfaces, storage resources, network interfaces, motherboards, and/or any other components and/or elements of an information handling system.

FIG. 1 illustrates a block diagram of an example information handling system 102 having a BIOS 110 configured to enforce credential isolation among multiple operating systems, in accordance with certain embodiments of the present disclosure. In some embodiments, information handling system 102 may be a server. In other embodiments, information handling system 102 may be a personal computer (e.g., a desktop computer or a portable computer). As depicted in FIG. 1, information handling system 102 may include a processor 103, a memory 104 communicatively coupled to processor 103, and a BIOS 110 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 110 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a UEFI. In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

As shown in FIG. 1, BIOS 110 may have stored thereon and/or stored on computer-readable media accessible to BIOS 110 a platform key 112, one or more key exchange keys 114, a key exchange key association map 116, one or more authorized databases 118, and one or more unauthorized databases 120. Although platform key 112, key exchange keys 114, key exchange key association map 116, authorized databases 118, and unauthorized databases 120 are depicted in FIG. 1 as integral to BIOS, in some embodiments one or more of such components may be stored on computer-readable media external to but accessible by BIOS 110.

Platform key 112 may comprise a public key (e.g., of a public/private key pair) installed in BIOS 110 by an original equipment manufacturer during manufacture of information handling system 102 and/or BIOS 110. Platform key 112 may ensure security of information handling system 102 by controlling access to a database of key exchange keys 114 associated with BIOS 110. For example, platform key 112 may be used to verify a digital signature (e.g., signed with a private key corresponding to the platform key 112) to any call, message, or instruction to add, delete, and/or modify a key exchange key 114.

A key exchange key 114 may comprise a public key (e.g., of a public/private key pair) installed in BIOS 110 and authorized by platform key 112, and may be associated with a particular operating system vendor. A key exchange key may only be updated by a call, message, or instruction to add, delete, and/or modify a key exchange key 114 signed with platform key 112. In some instances, BIOS 110 may include multiple key exchange keys 114, each key exchange key 114 associated with an operating system configured to execute on information handling system 102 and each key exchange key 114 configured to allow or authorize execution of particular drivers or other executable code in connection with the operating system.

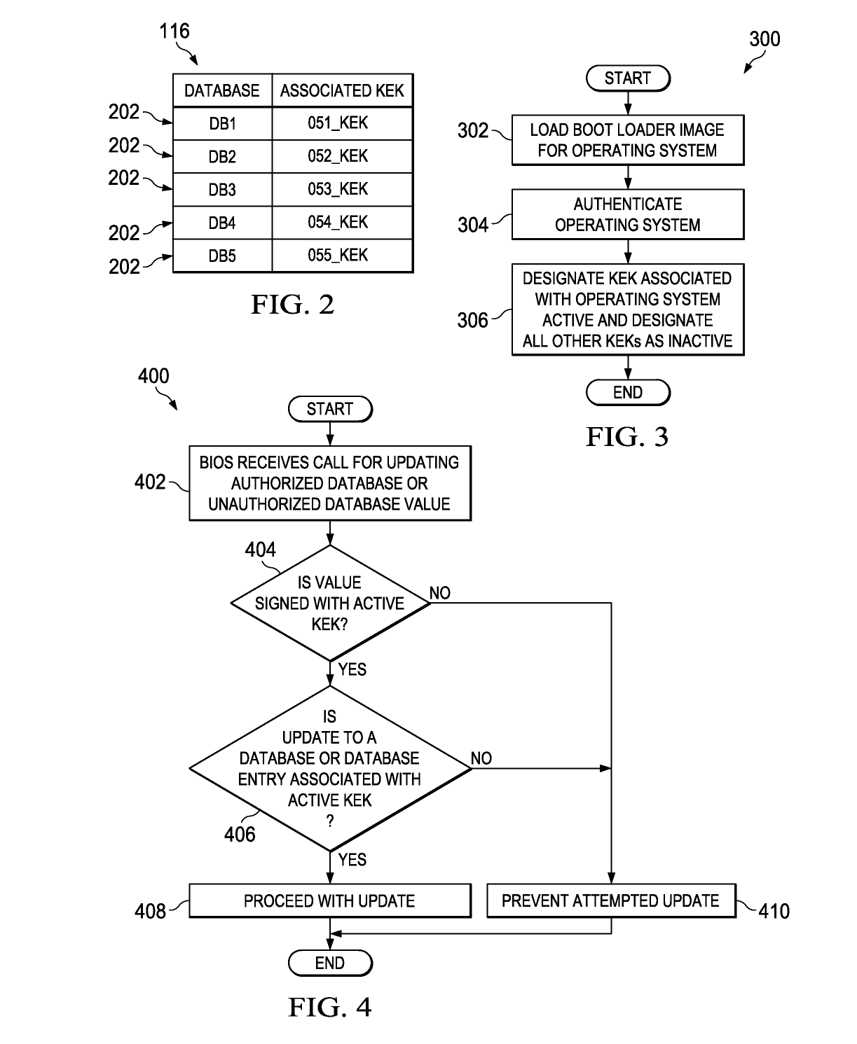

Key exchange key association map 116 may include any list, table, database, map, or other data structure having one or more entries 202 relating each of one or more key exchange keys 114 to one or more of an authorized database 118 and/or an unauthorized database 120. An example of a key exchange key association map 116 is shown in FIG. 2. In the example key exchange key association map 116, a database (e.g., an authorized database 118 or an unauthorized database 120) with an identifier of “DB1” may be associated with a key exchange key 114 with an identifier of “OS1_KEK,” a database with an identifier of “DB2” may be associated with a key exchange key 114 with an identifier of “OS2_KEK,” and so on. Accordingly, each entry 202 may set forth a particular database (e.g., an authorized database 118 or an unauthorized database 120) and the associated key exchange key 114 permitted to make additions, deletions, and/or modifications to such database.

An authorized database 118 may include any list, table, database, map, or other data structure setting forth a list of allowable keys to validate digital signatures of drivers or other executable code to be executed in connection with an operating system. In embodiments of this disclosure, each authorized database 118 may be associated with a particular key exchange key 114, as set forth in key exchange key association map 116. In some embodiments, an authorized database 118 may comprise a DB as defined in the UEFI specification.

An unauthorized database 120 may include any list, table, database, map, or other data structure setting forth a list of keys that when used to digitally sign drivers or other executable code, are to be refused execution in connection with an operating system. In embodiments of this disclosure, each unauthorized database 120 may be associated with a particular key exchange key 114, as set forth in key exchange key association map 116. In some embodiments, an unauthorized database 120 may comprise a DBX as defined in the UEFI specification.

In operation, BIOS 110 may maintain associations between a database (e.g., an authorized database 118 or an unauthorized database 120) and the key exchange key 114 used to create entries in the particular database. When a Secure Boot subsystem of BIOS 110 authenticates and boots to a securely booted operating system, BIOS 110 may note the database used to validate the boot loader of the operating system, and from such information, designate the key exchange key 114 associated with the securely booted operating system as an active key exchange key, and designate all other key exchange keys 114 as inactive. When BIOS 110 receives a call, message, or command for updating any value in an authorized database 118 or unauthorized database 120, BIOS 110 will verify whether the new value is signed with the active key exchange key 114, and only permit the update if the new value is signed with the active key exchange key 114. Thus, only the active key exchange key would be permitted to add values at an authorized database 118 or unauthorized database 120 during a boot session, and BIOS 110 would also ensure that the operating system associated with the active key exchange key can only delete or update database entries in an authorized database 118 or unauthorized database 120 that are associated with such active key exchange key.

FIG. 3 illustrates a flow chart of an example method 300 for initializing an information handling system to enforce credential isolation among multiple operating systems, in accordance with certain embodiments of the present disclosure. According to one embodiment, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, in response to a powering on or boot up of information handling system 102, BIOS 110 may load a bootloader image for an operating system. At step 304, BIOS 110 may authenticate the operating system (e.g., by verifying a digital signature of the operating system with an associated key exchange key 114).

At step 306, BIOS 110 may designate the key exchange key 114 associated with the operating system as the active key exchange key, and designate all other key exchange keys 114 as inactive key exchange keys. After completion of step 306, method 300 may end.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

FIG. 4 illustrates a flow chart of an example method 400 for enforcing credential isolation among multiple operating systems, in accordance with embodiments of the present disclosure. According to one embodiment, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, BIOS 110 may receive a call for updating a value (e.g., deleting or modifying) in an authorized database 118 or an unauthorized database 120. At step 404, BIOS 110 may determine whether the value is signed with the active key exchange key 114. If the value is signed with the active key exchange key 114, method 400 may proceed to step 406. Otherwise, method 400 may proceed to step 410.

At step 406, BIOS 110 may determine if the update is to a database associated with the active key exchange key 114. If the update is to a database or database entry associated with the active key exchange key 114, method 400 may proceed to step 408. Otherwise, method 400 may proceed to step 410.

At step 408, in response to determinations that the value is signed with the active key exchange key 114 and that the update is to a database or database entry associated with the active key exchange key 114, BIOS 110 may proceed with the requested update. After completion of step 408, method 400 may end.

At step 410, in response to a determination that the value is not signed with the active key exchange key 114 or that the update is not to a database or database entry associated with the active key exchange key 114, BIOS 110 may prevent the requested update. After completion of step 410, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using information handling system 102 or any other system operable to implement method 400. In certain embodiments, method 400 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
a basic input/output system (BIOS) comprising a program of instructions executable by the processor and configured to cause the processor to:
during a boot of the information handling system, authenticate an operating system for execution on the information handling system based on a key exchange key associated with the operating system;
designate the key exchange key as an active key exchange key for a boot session of the information handling system; and
during the boot session, in response to a call for updating a value of an authorized database of keys associated with executable code permitted to execute on the information handling system or an authorized database of keys associated with executable code forbidden to execute on the information handling system:
determine whether the value is digitally signed with the active key exchange key;
determine whether the update is to a database or database entry associated with the active key exchange key; and
process the update in response to determinations that the value is digitally signed with the active key exchange key and that the update is to a database or database entry associated with the active key exchange key.

2. The information handling system of claim 1, wherein the authorized database is a DB as defined by the Unified Extensible Firmware Interface.

3. The information handling system of claim 1, wherein the unauthorized database is a DBX as defined by the Unified Extensible Firmware Interface.

4. The information handling system of claim 1, the BIOS further configured to cause the processor to prevent the update in response to at least one of:
a determination that the value is not digitally signed with the active key exchange key; and
a determination that the update is not to a database or database entry associated with the active key exchange key.

5. A method comprising:
during a boot of the information handling system, authenticating an operating system for execution on an information handling system based on a key exchange key associated with the operating system;
designating the key exchange key as an active key exchange key for a boot session of the information handling system; and
during the boot session, in response to a call for updating a value of an authorized database of keys associated with executable code permitted to execute on the information handling system or an authorized database of keys associated with executable code forbidden to execute on the information handling system:
determining whether the value is digitally signed with the active key exchange key;
determining whether the update is to a database or database entry associated with the active key exchange key; and
processing the update in response to determinations that the value is digitally signed with the active key exchange key and that the update is to a database or database entry associated with the active key exchange key.

6. The method of claim 5, wherein the authorized database is a DB as defined by the Unified Extensible Firmware Interface.

7. The method of claim 5, wherein the unauthorized database is a DBX as defined by the Unified Extensible Firmware Interface.

8. The method of claim 5, further comprising preventing the update in response to at least one of:
a determination that the value is not digitally signed with the active key exchange key; and
a determination that the update is not to a database or database entry associated with the active key exchange key.

9. An article of manufacture comprising:
a computer readable medium; and
computer-executable instructions carried on the computer readable medium, the instructions readable by a processor, the instructions, when read and executed, for causing the processor to:
during a boot of the information handling system, authenticate an operating system for execution on an information handling system based on a key exchange key associated with the operating system;
designate the key exchange key as an active key exchange key for a boot session of the information handling system; and
during the boot session, in response to a call for updating a value of an authorized database of keys associated with executable code permitted to execute on the information handling system or an authorized database of keys associated with executable code forbidden to execute on the information handling system:
determine whether the value is digitally signed with the active key exchange key;
determine whether the update is to a database or database entry associated with the active key exchange key; and
process the update in response to determinations that the value is digitally signed with the active key exchange key and that the update is to a database or database entry associated with the active key exchange key.

10. The article of claim 9, wherein the authorized database is a DB as defined by the Unified Extensible Firmware Interface.

11. The article of claim 9, wherein the unauthorized database is a DBX as defined by the Unified Extensible Firmware Interface.

12. The article of claim 9, the instructions for further causing the processor to prevent the update in response to at least one of:
a determination that the value is not digitally signed with the active key exchange key; and
a determination that the update is not to a database or database entry associated with the active key exchange key.
